(19) United States
(12) Patent Application Publication
(10) Pub. No.: US 2014/0079932 A1
(43) Pub. Date: Mar. 20, 2014

(54) NANO-GRAPHENE AND NANO-GRAPHENE OXIDE

(71) Applicant: The Trustees of Princeton University, Princeton, NJ (US)

(72) Inventors: Ilhan A. AKSAY, Princeton, NJ (US); Michael Pope, Princeton, NJ (US); Joseph Roy-Mayhew, Princeton, NJ (US)

(73) Assignee: The Trustees of Princeton University, Princeton, NJ (US)

(21) Appl. No.: 14/017,869

(22) Filed: Sep. 4, 2013

Related U.S. Application Data
(60) Provisional application No. 61/696,565, filed on Sep. 4, 2012.

(51) Int. Cl. C01B 31/04

(52) U.S. Cl. CPC C01B 31/0446; C01B 31/043
USPC 428/219; 423/415.1; 423/448; 428/220

(57) ABSTRACT

Nano-graphene oxide sheets or nano-graphene sheets having a maximum average lateral dimension of about 50 nm and methods of making nano-graphene oxide sheets and nano-graphene sheets.

### STATEMENT REGARDING FEDERALLY SPONSORED RESEARCH AND DEVELOPMENT

This invention was made with government support provided by the ARRA/AFOSR under grant number FA9550-09-1-0523. The government has certain rights in the invention.

### FIELD OF THE INVENTION

The present invention relates to nano-graphene oxide sheets and nano-graphene sheets and methods of making the same.

### BACKGROUND

Due to its many excellent properties, graphene is increasingly being used in myriad practical applications, including in electronics, sensors (such as gas sensors biosensors, etc.), electrodes, thermal transfer applications, energy storage devices (such as batteries and supercapacitors), solar cells, polymer composites, electrically conductive inks and coatings, etc. Most large scale production methods yield graphene having lateral dimensions measured in the hundreds of nanometers to microns. It would be useful for many applicationsto use graphene having smaller lateral dimensions.

Microporous and Mesoporous Materials 2007, 102, 178 studies the relationship between the reactivity and surface properties of carbons and their crystalline structure.

### SUMMARY OF THE INVENTION

Disclosed and claimed herein are nano-graphene oxide sheets and nano-graphene sheets having a maximum average lateral dimension of about 100 nm. Further disclosed and claimed are a method of making nano-graphene oxide sheets, comprising oxidizing at least one carbonaceous material having graphitic domains and a method of making nano-graphene sheets, comprising reducing nano-graphene oxide sheets having a maximum average lateral dimension of about 50 nm.

### BRIEF DESCRIPTION OF THE DRAWINGS

FIG. 1 shows a photoluminescence spectrum of nano-graphene sheets.

### DETAILED DESCRIPTION OF THE INVENTION

As used herein, the term “nano-graphene sheets” can refer to both single-atom-thick planar sheets of sp²hybridized carbon as well as materials comprising two or more stacked layers of such sheets (such as partially exfoliated graphite (where a single sheet would be considered fully exfoliated graphite). The planar sheets of sp² hybridized carbon may form an essentially hexagonal lattice. The graphene sheets may contain defects that prevent them from being in the form of a perfect hexagonal lattice and may, for example, contain sp³hybridized carbons or heteroatoms. The graphene sheets may be functionalized and contain heteroatoms such as oxygen.

Similarly, as used herein, the term “nano-graphite oxide sheets” can refer to single-atom thick planar sheets of graphite oxide as well as materials comprising two or more stacked layers of such sheets.

The nano-graphene oxide sheets and nano-graphene sheets of the present invention can in some embodiments have number average maximum lateral dimensions of from about 0.5 nm to about 100 nm, or about from 0.5 nm to about 75 nm, or about from 0.5 nm to about 50 nm, or about from 0.5 nm to about 40 nm, or of from about 0.5 nm to about 30 nm, or of from about 0.5 nm to about 15 nm, or of from about 0.5 nm to about 10 nm, or of from about 0.5 nm to about 5 nm, or of from about 1 nm to about 50 nm, or of from about 1 nm to about 40 nm, or of from about 1 nm to about 30 nm, or of from about 1 nm to about 15 nm, or of from about 1 nm to about 10 nm, or of from about 1 nm to about 5 nm, or of from about 2 nm to about 50 nm, or of from about 2 nm to about 40 nm, or of from about 2 nm to about 30 nm, or of from about 2 nm to about 15 nm, or of from about 2 nm to about 10 nm, or of from about 2 nm to about 5 nm. By “lateral dimensions” is meant dimensions taken from edge-to-edge across the sp² hybridized carbon plane.

The nano-graphene oxide sheets and nano-graphene sheets of the present invention can in some embodiments have number average thickness of from about 0.33 nm to about 50 nm, or from about 0.33 nm to about 30 nm, or from about 0.33 nm to about 20 nm, or from about 0.33 nm to about 10 nm, or from about 0.33 nm to about 4 nm, or from about 0.33 nm to about 2 nm, or from about 0.7 nm to about 50 nm, or from about 0.7 nm to about 30 nm, or from about 0.7 nm to about 20 nm, or from about 0.7 nm to about 10 nm, or from about 0.7 nm to about 4 nm, or from about 0.7 nm to about 2 nm. The nano-graphene oxide sheets and nano-graphene sheets of the present invention can in some embodiments comprise single sheets, two sheets, three sheets, four sheets, five sheets, six sheets, seven sheets, eight sheets, nine sheets, and/or ten sheets of the single-atom thick planar sheet. They may comprise blends of particles comprising two or more of the foregoing thicknesses.

The nano-graphene oxide sheets are made by oxidizing carbonaceous materials having small (nanometer scale)graphite crystalline domains. Examples of carbonaceous materials include mesoporous carbons, graphitized mesoporous carbons, carbon black, conductive carbon black, activated carbon, black carbon (soot), and the like. Examples include Ketjenblack® EC series (supplied by AkzoNobel); Monarch®, Vulcan®, Black Pearls®, and Regal® carbon blacks supplied by Cabot; Super P® carbon black (supplied by TIMCAL); lampblack; etc.

The carbonaceous materials can be produced by thermolyzing hydrocarbon vapors or liquids under controlled conditions. Due to the small size of crystalline domains, the materials may appear amorphous by some characterization techniques. High resolution characterization techniques such as transmission electron microscopy can be used in some cases to observe crystallinity. In some cases, the carbonaceous materials are about 50 to about 95 weight percent crystalline.

In some cases, the carbonaceous materials are pre-processed prior to the oxidation. This can be used to expose crystalline domains. Examples of pretreatment methods include treating the carbonaceous materials with nitric acid (such as under reflux), oxidation with oxygen, air, ozone, etc.; and the like.

Oxidation may be carried out by treating the carbonaceous materials with one or more oxidizing agents and, optionally, intercalating agents, and catalysts. Examples of oxidizing agents include nitric acid, nitrates (such as sodium and potassium nitrates), perchlorates (such as sodium, potassium, lithium, ammonium, etc. perchlorate), potassium chlorate, sodium chlorate, chromic acid, potassium chromate, sodium chromate, potassium dichromate, sodium dichromate, hydrogen peroxide, sodium and potassium permanganates, phosphoric acid (H₃PO₄), phosphorus pentoxide, bisulfites, sodium bisulfate, potassium bisulfate, sodium persulfate, and potassium persulfate, etc. Preferred oxidants include KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Preferred catalysts for the oxidation include nitrates (such as sodium and potassium nitrate) or H₃PO₄. Examples of methods of making graphite oxide include those described by Staudenmaier (Ber. Stsch. Chem. Ges. (1898), 31, 1481) and Hummers (J. Am. Chem. Soc. (1958), 80, 1339).

Nano-graphene oxide sheets can be reduced to form nano-graphene sheets using any suitable method and can be carried out on the nano-graphene oxide sheets in dry form, in a dispersion, etc. They may be reduced chemically. Examples of useful chemical reducing agents include, but are not limited to, hydrazines (such as hydrazine, N,N-dimethylhydrazine, etc. in liquid and vapor forms), sodium borohydride, citric acid, hydroquinone, isocyanates (such as phenyl isocyanate), hydrogen, hydrogen plasma, etc. . . . A dispersion or suspension of nano-graphite oxide sheets in a carrier (such as water, organic solvents, or a mixture of solvents) can be made using any suitable method (such as ultrasonication and/or mechanical grinding or milling) and reduced to nano-graphene sheets. Nano-graphene oxide sheets can be reduced solvothermally, such as by treatment in water, alcohol (such as ethanol), etc. at elevated temperatures (e.g. ca. 90 to ca. 350° C.).

Nano-graphene oxide sheets can be thermally exfoliated and/or reduced to form nano-graphene sheets. One suitable method is described in US 2007/0092432, the disclosure of which is hereby incorporated herein by reference.

Thermal exfoliation and/or can be carried out in a continuous, semi-continuous batch, etc. process. Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel. Heating can be done using a flash lamp, microwaves, etc. During heating, the graphite oxide can be contained in an essentially constant location in single batch reaction vessel, or can be transported through one or more vessels during the reaction in a continuous or batch mode. Heating can be done using any suitable means, including the use of furnaces and infrared heaters.

Examples of temperatures at which the thermal exfoliation and/or reduction of graphite oxide can be carried out are at least about 150° C., at least about 200° C., at least about 300° C., at least about 400° C., at least about 450° C., at least about 500° C., at least about 600° C., at least about 700° C., at least about 750° C., at least about 800° C., at least about 850° C., at least about 900° C., at least about 950° C., at least about 1000° C., at least about 1100° C., at least about 1500° C., at least about 2000° C., and at least about 2500° C. Preferred ranges include between about 750 about and 3000° C., between about 850 and 2500° C., between about 950 and about 2500° C., between about 950 and about 1500° C., between about 750 about and 3100° C., between about 850 and 2500° C., or between about 950 and about 2500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature can vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

The nano-graphite oxide sheets can be rapidly heated to perform an initial exfoliation and/or reduction and the resulting nano-graphene sheets can be further reduced by additional heating, including at temperatures such as those given above. Such additional reduction can increase the carbon to oxygen ratio and remove defects (such as heteroatoms and sp³ hybridized carbons atoms). Preferred temperatures include least about 950° C., at least about 1000° C., at least about 1100° C., at least about 1500° C., at least about 2000° C., and at least about 2500° C.

The heating can be done under a variety of conditions, including in an inert atmosphere (such as argon or nitrogen) or a reducing atmosphere, such as hydrogen (including hydrogen diluted in an inert gas such as argon or nitrogen), or under vacuum. The heating can be done in any appropriate vessel, such as a fused silica or a mineral or ceramic vessel or a metal vessel. The materials being heated including any starting materials and any products or intermediates) can be contained in an essentially constant location in single batch reaction vessel, or can be transported through one or more vessels during the reaction in a continuous or batch reaction. Heating can be done using any suitable means, including the use of furnaces and infrared heaters.

The nano-graphene sheets and nano-graphene oxide sheets preferably have a surface area of from about 100 to about 2630 m²/g or of at least about 100 m²/g to, or of at least about 200 m²/g, or of at least about 300 m²/g, or of least about 350 m²/g, or of least about 400 m²/g, or of least about 500 m²/g, or of least about 600 m²/g., or of least about 700 m²/g, or of least about 800 m²/g, or of least about 900 m²/g, or of least about 1000 m²/g, or of least about 1100 m²/g, or of least about 1200 m²/g, or of least about 1300 m²/g, or of least about 1400 m²/g, or of least about 1500 m²/g, or of least about 1600 m²/g, or of least about 1700 m²/g, or of least about 1800 m²/g, or of least about 2000 m²/g, or of least about 2200 m²/g. The surface area can be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

Surface area can be measured using either the nitrogen adsorption/BET method at 77 K or a methylene blue (MB) dye method in liquid solution. The dye method is carried out as follows: A known amount of graphene is added to a flask. At least 1.5 g of MB are then added to the flask per gram of graphene. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations. The difference between the amount of MB that was initially added and the amount present in solution as determined by UV-vis spectrophotometry is assumed to be the amount of MB that has been adsorbed onto the surface of the graphene. The surface area of the graphene is then calculated using a value of 2.54 m² of surface covered per one mg of MB adsorbed.

The nano-graphene oxide sheets typically have an overall carbon to oxygen molar ratio (C/O), as determined by bulk elemental analysis, of between about 1:2 to about 10:1, or between about 1:1 to about 10:1, or between about 1:1 to about 8:1, or between about 1:1 to about 7:1, or between about 1:2 to about 10:1, or between about 1:2 to about 8:1.

The nano-graphene sheets can be functionalized with, for example, oxygen-containing functional groups (including, for example, hydroxyl, carboxyl, and epoxy groups) and typically have an overall C/O, as determined by bulk elemental analysis, of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 400:1; about 3:2 to about 500:1; about 3:2 to about 1000:1; about 3:2 to greater than 1000:1; about 3:1 to about 30:1; about 3:1 to about 20:1; about 3:1 to about 15:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 15:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The nano-graphene sheets can contain atomic scale kinks. These kinks can be caused by the presence of lattice defects in, or by chemical functionalization of the two-dimensional hexagonal lattice structure of the graphite basal plane.

The nano-graphite oxide and nano-graphene sheets can be used in many applications. They may be combined with other materials to make different compositions. They can be combined with polymers to make composites, inks and coatings, etc. They can be dispersed in one or more solvents without a polymer binder. The inks can be used to make very fine patterns having dimensions on the scale of tens of nanometers. They can be used in electrodes, such as those used in solar cells (including dye-sensitized solar cells, organic solar cells, etc.), light-emitting diodes, batteries (such as electrodes for use in rechargeable, lithium ion, lithium polymer, lithium air, etc. batteries), capacitors (including ultracapacitors), etc. They can be used as dyes in dye-sensitized solar cells, as they can have high molar extinction coefficients, absorb over a wide range of wavelengths, and don't contain rare metals. They can be used as combustion additives to enhance fuel burn rates or initiate combustion; surfactants to help disperse larger graphene sheets or nanotubes in polymers, solvents, and other media; in drug delivery devices; in RFID shielding applications; in sensors (such as biosensors); as electrocatalysts (such as for NADH or I₃⁻ reduction); etc. They can be used as pillars between larger graphene sheets to form extended graphene-based structures. In such a case, for example, functional groups on the ends of nano-graphene sheets could bond or interact with the basal plane of the larger graphene sheets. Polymer composites can be used in gas barrier applications. Rubber composites can be used in tire applications.

The nano-graphite oxide and nano-graphene sheets can be combined with polymers using any suitable method, including melt processing (using, for example, a single or twin-screw extruder, a blender, a kneader, a Banbury mixer, etc.) and solution/dispersion blending. When used, binders can be thermosets, thermoplastics, non-melt processible polymers, etc. Binders can also comprise monomers that can be polymerized before, during, or after the application of the coating to the substrate. Polymeric binders can be crosslinked or otherwise cured after the coating has been applied to the substrate. Examples of polymers include, but are not limited to polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral) (PVB), poly(vinyl formal), poly(methyl methacrylate) and other acrylate polymers and copolymers (such as methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), poly(vinyl acetate) and poly(vinyl acetate) copolymers, poly(vinyl pyrrolidone) and poly(vinyl pyrrolidone) copolymers, vinyl acetate and vinyl pyrrolidone copolymers, polycarbonates (PC), polyamides, polyesters, liquid crystalline polymers (LCPs), poly(lactic acid) (PLA), poly(phenylene oxide) (PPO), PPO-polyamide alloys, polysulphone (PSU), polysulfides, polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), and poly(vinyl chloride), polyurethanes (thermoplastic and thermosetting), aramides (such as Kevlar® and Nomex®), polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane), etc.), elastomers, epoxy polymers, polyureas, alkyds, cellulosic polymers (such as nitrocellulose, ethyl cellulose, ethyl hydroxyethyl cellulose, carboxymethyl cellulose, cellulose acetate, cellulose acetate propionates, and cellulose acetate butyrates), polyethers (such as poly(ethylene oxide), poly(propylene oxide), poly(propylene glycol), oxide/propylene oxide copolymers, etc.), acrylic latex polymers, polyester acrylate oligomers and polymers, polyester dioldiacrylate polymers, UV-curable resins, etc.

Examples of elastomers include, but are not limited to, polyurethanes, copolyetheresters, rubbers (including butyl rubbers and natural rubbers), styrene/butadiene copolymers, styrene/ethylene/butadiene/styrene copolymer (SEBS), polyisoprene, ethylene/propylene copolymers (EPR), ethylene/propylene/diene monomer copolymers (EPDM), polysiloxanes, and polyethers (such as poly(ethylene oxide), poly(propylene oxide), and their copolymers).

Examples of polyamides include, but are not limited to, aliphatic polyamides (such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylyleneadipamide) (polyamide MXD,6)) and polyterephthalamides such as poly(dodecamethyleneterephthalamide) (polyamide 12,T), poly(decamethyleneterephthalamide) (polyamide 10,T), poly(nonamethyleneterephthalamide) (polyamide 9,T), the polyamide of hexamethyleneterephthalamide and hexamethyleneadipamide, the polyamide of hexamethyleneterephthalamide, and 2-methylpentamethyleneterephthalamide), etc. The polyamides may be polymers and copolymers (i.e., polyamides having at least two different repeat units) having melting points between about 120 and 255° C. including aliphatic copolyamides having a melting point of about 230° C. or less, aliphatic copolyamides having a melting point of about 210° C. or less, aliphatic copolyamides having a melting point of about 200° C. or less, aliphatic copolyamides having a melting point of about 180° C. or less, etc. Examples of these include those sold under the trade names Macromelt by Henkel and Versamid by Cognis.

Examples of acrylate polymers include those made by the polymerization of one or more acrylic acids (including acrylic acid, methacrylic acid, etc.) and their derivatives, such as esters. Examples include methyl acrylate polymers, methyl methacrylate polymers, and methacrylate copolymers. Examples include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidylmethacrylates, 2-ethylhexyl acrylate, 2-ethylhexyl methacrylate, hydroxyethyl acrylate, hydroxyethyl (meth)acrylate, acrylonitrile, and the like. The polymers may comprise repeat units derived from other monomers such as olefins (e.g. ethylene, propylene, etc.), vinyl acetates, vinyl alcohols, vinyl pyrrolidones, etc. They may include partially neutralized acrylate polymers and copolymers (such as ionomer resins).

Examples of polymers include Elvacite® polymers supplied by Lucite International, Inc., including Elvacite® 2009, 2010, 2013, 2014, 2016, 2028, 2042, 2045, 2046, 2550, 2552,2614, 2669, 2697, 2776, 2823, 2895, 2927, 3001, 3003, 3004, 4018, 4021, 4026, 4028, 4044, 4059, 4400, 4075, 4060, 4102, etc. Other polymer families include Bynel® polymers (such as Bynel® 2022 supplied by DuPont) and Joncryl® polymers (such as Joncryl® 678 and 682).

Examples of polyesters include, but are not limited to, poly(butylene terephthalate) (PBT), poly(ethylene terephthalate) (PET), poly(1,3-propylene terephthalate) (PPT), poly(ethylene naphthalate) (PEN), poly(cyclohexanedimethanol terephthalate) (PCT)), etc.

Examples of solvents into which the nano-graphite oxide and nano-graphene sheets can be dispersed include water, distilled or synthetic isoparaffinic hydrocarbons (such Isopar® and Norpar® (both manufactured by Exxon) and Dowanol® (manufactured by Dow), citrus terpenes and mixtures containing citrus terpenes (such as Purogen, Electron, and Positron (all manufactured by Ecolink)), terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate, etc.), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol (such as Hexasol™ (supplied by SpecialChem)), dibasic esters (such as dimethyl succinate, dimethyl glutarate, dimethyl adipate), dimethylsulfoxide (DMSO), 1,3-dimethyl-3,4,5,6-tetrahydro-2(1H)-pyrimidinone (DMPU), imides, amides (such as dimethylformamide (DMF), dimethylacetamide, etc.), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)),and mixtures of two or more of the foregoing and mixtures of one or more of the foregoing with other carriers. Solvents can be low- or non-VOC solvents, non-hazardous air pollution solvents, and non-halogenated solvents.

Compositions containing nano-graphene oxide sheets and/or nano-graphene sheets can contain additives such as dispersion aids (including surfactants, emulsifiers, and wetting aids), adhesion promoters, thickening agents (including clays), defoamers and antifoamers, biocides, additional fillers, flow enhancers, stabilizers, crosslinking and curing agents, conductive additives, etc.

Examples of dispersing aids include glycol ethers (such as poly(ethylene oxide), block copolymers derived from ethylene oxide and propylene oxide (such as those sold under the trade name Pluronic® by BASF), acetylenicdiols (such as 2,5,8,11-tetramethyl-6-dodecyn-5,8-diol ethoxylate and others sold by Air Products under the trade names Surfynol® and Dynol®), salts of carboxylic acids (including alkali metal and ammonium salts), and polysiloxanes.

Examples of grinding aids include stearates (such as Al, Ca, Mg, and Zn stearates) and acetylenicdiols (such as those sold by Air Products under the trade names Surfynol® and Dynol®).

Examples of adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and others sold by Johnson-Matthey Catalysts under the trade name Vertec.

Examples of thickening agents include glycol ethers (such as poly(ethylene oxide), block copolymers derived from ethylene oxide and propylene oxide (such as those sold under the trade name Pluronic® by BASF), long-chain carboxylate salts (such aluminum, calcium, zinc, etc. salts of stearates, oleats, palmitates, etc.), aluminosilicates (such as those sold under the Minex® name by Unimin Specialty Minerals and Aerosil® 9200 by Evonik Degussa), fumed silica, natural and synthetic zeolites, etc.

Compositions may contain electrically and/or thermally conductive components, such as metals (including metal alloys), conductive metal oxides, conductive carbons, polymers, metal-coated materials, etc. These components can take a variety of forms, including particles, powders, flakes, foils, needles, etc.

Examples of metals include, but are not limited to silver, copper, aluminum, platinum, palladium, nickel, chromium, gold, bronze, colloidal metals, etc. Examples of metal oxides include antimony tin oxide and indium tin oxide and materials such as fillers coated with metal oxides. Metal and metal-oxide coated materials include, but are not limited to metal coated carbon and graphite fibers, metal coated glass fibers, metal coated glass beads, metal coated ceramic materials (such as beads), etc. These materials can be coated with a variety of metals, including nickel.

Examples of electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis(3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polyisonaphthalene, polyaniline, polypyrrole, poly(phenylene sulfide), polycarbozoles, polyindoles, polyphenylenes, copolymers of one or more of the foregoing, etc., and their derivatives and copolymers. The conductive polymers may be doped or undoped. They may be doped with boron, phosphorous, iodine, etc.

Examples of conductive carbons include, but are not limited to, graphite (including natural, Kish, and synthetic, annealed, pyrolytic, highly oriented pyrolytic, etc. graphites), graphitized carbon, carbon black, carbon fibers and fibrils, carbon whiskers, vapor-grown carbon nanofibers, metal coated carbon fibers, carbon nanotubes (including single- and multi-walled nanotubes), fullerenes, activated carbon, carbon fibers, expanded graphite, expandable graphite, graphite oxide, hollow carbon spheres, carbon foams, etc.

The nano-graphene sheets and nano-graphene oxide sheets can be blended with graphene and/or graphene oxide sheets having number average maximum lateral dimensions of greater than about 100 nm, such as those having dimensions of about 100 nm to about 30 microns, or about 100 nm to about 15 microns, or about 100 nm to about 10 microns, or about 100 nm to about 5 microns, or about 100 nm to about 1 micron, or about 100 nm to about 750 nm, or about 100 nm to about 500 nm, or about 200 nm to about 30 microns, or about 200 nm to about 15 microns, or about 200 nm to about 10 microns, or about 200 nm to about 5 microns, or about 200 nm to about 1 micron, or about 200 nm to about 750 nm, or about 200 nm to about 500 nm, or about 500 nm to about 30 microns, or about 500 nm to about 15 microns, or about 500 nm to about 10 microns, or about 500 nm to about 5 microns, or about 500 nm to about 1 micron, or about 500 nm to about 750 nm, or about 750 nm to about 30 microns, or about 750 nm to about 15 microns, or about 750 nm to about 10 microns, or about 750 nm to about 5 microns, or about 750 nm to about 1 micron, or about 1 micron to about 15 microns, or about 1 micron to about 10 microns, or about 1 micron to about 5 microns, or about 2 microns to about 10 microns.

Dispersions, suspensions, solutions, etc. of nano-graphite oxide sheets and/or nano-graphene sheets (including inks and coatings formulations) can be made or processed (e.g., milled/ground, blended, dispersed, suspended, etc.) by using suitable mixing, dispersing, and/or compounding techniques and apparatus, including ultrasonic devices, high-shear mixers, ball mills, attrition equipment, sandmills, two-roll mills, three-roll mills, cryogenic grinding crushers, extruders, kneaders, double planetary mixers, triple planetary mixers, high pressure homogenizers, ball mills, horizontal and vertical wet grinding mills, etc. Processing (including grinding) technologies can be wet or dry and can be continuous or discontinuous. Suitable materials for use as grinding media include metals, carbon steel, stainless steel, ceramics, stabilized ceramic media (such as yttrium stabilized zirconium oxide), PTFE, glass, tungsten carbide, etc.

Inks and coatings can be formed by blending the nano-graphene oxide sheets and/or nano-graphene sheets with at least one solvent and/or binder, and, optionally, other additives. Blending can be done using one or more of the preceding methods.

Inks and coatings can be applied to a wide variety of substrates, including, but not limited to, flexible and/or stretchable materials, silicones and other elastomers and other polymeric materials, metals (such as aluminum, copper, steel, stainless steel, etc.), adhesives, fabrics (including cloths) and textiles (such as cotton, wool, polyesters, rayon, etc.), clothing, glasses and other minerals, ceramics, silicon surfaces, wood, paper, cardboard, paperboard, cellulose-based materials, glassine, labels, silicon and other semiconductors, laminates, corrugated materials, concrete, bricks, and other building materials, etc. Substrates may in the form of films, papers, wafers, larger three-dimensional objects, etc.

The substrates may have been treated with other coatings (such as paints) or similar materials before the inks and coatingsare applied. Examples include substrates (such as PET) coated with indium tin oxide, antimony tin oxide, etc. They may be woven, nonwoven, in mesh form; etc. They may be woven, nonwoven, in mesh form; etc.

The substrates may be paper-based materials generally (including paper, paperboard, cardboard, glassine, etc.). Paper-based materials can be surface treated. Examples of surface treatments include coatings such as polymeric coatings, which can include PET, polyethylene, polypropylene, acetates, nitrocellulose, etc. Coatings may be adhesives. Paper based materials may be sized.

Examples of polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid), etc).; polystyrene; polyamides (including polyterephthalamides); polyimides (such as Kapton®); aramids (such as Kevlar® and Nomex®); fluoropolymers (such as fluorinated ethylene propylene (FEP), polytetrafluoroethylene (PTFE), poly(vinyl fluoride), poly(vinylidene fluoride), etc.); polyetherimides; poly(vinyl chloride); poly(vinylidene chloride); polyurethanes (such as thermoplastic polyurethanes (TPU); spandex, cellulosic polymers (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); Mylar; etc. They may be non-woven materials, such as DuPont Tyvek®. They may be adhesive or adhesive-backed materials (such as adhesive-backed papers or paper substitutes). They may be mineral-based paper substitutes such as Teslin® from PPG Industries. The substrate may be a transparent or translucent or optical material, such as glass, quartz, polymer (such as polycarbonate or poly(meth)acrylates (such as poly(methyl methacrylate).

The inks and coatings may be applied to the substrate using any suitable method, including, but not limited to, painting, pouring, spin casting, solution casting, dip coating, powder coating, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing (a method of which is described in WO 2007/053621, which is hereby incorporated herein by reference), microprinting, pad printing, tampon printing, stencil printing, wire rod coating, drawing, flexographic printing, stamping, xerography, microcontact printing, dip pen nanolithography, laser printing, via pen or similar means, etc. The compositions can be applied in multiple layers.

After they have been applied to a substrate, the inks and coatings may be cured using any suitable technique, including drying and oven-drying (in air or another inert or reactive atmosphere), UV curing, IR curing, drying, crosslinking, thermal curing, laser curing, IR curing, microwave curing or drying, sintering, and the like.

The cured inks and coatings can have a variety of thicknesses. For example, they can optionally have a thickness of at least about 2 nm, or at least about 5 nm. In various embodiments, the coatings can optionally have a thickness of about 2 nm to 2 mm, about 5 nm to 1 mm, about 2 nm to about 100 nm, about 2 nm to about 200 nm, about 2 nm to about 500 nm, about 2 nm to about 1 micrometer, about 5 nm to about 200 nm, about 5 nm to about 500 nm, about 5 nm to about 1 micrometer, about 5 nm to about 50 micrometers, about 5 nm to about 200 micrometers, about 10 nm to about 200 nm, about 50 nm to about 500 nm, about 50 nm to about 1 micrometer, about 100 nm to about 10 micrometers, about 1 micrometer to about 2 mm, about 1 micrometer to about 1 mm, about 1 micrometer to about 500 micrometers, about 1 micrometer to about 200 micrometers, about 1 micrometer to about 100 micrometers, about 50 micrometers to about 1 mm, about 100 micrometers to about 2 mm, about 100 micrometers to about 1 mm, about 100 micrometers to about 750 micrometers, about 100 micrometers to about 500 micrometers, about 500 micrometers to about 2 mm, or about 500 micrometers to about 1 mm.

When applied to a substrate, the inks and coatings can have a variety of forms. They can be present as a film or lines, patterns, letters, numbers, circuitry, logos, identification tags, and other shapes and forms. The inks and coatings may be covered in whole or in part with additional material, such as overcoatings, varnishes, polymers, fabrics, etc.

The inks and coatings can be applied to the same substrate in varying thicknesses at different points and can be used to build up three-dimensional structures on the substrate.

The inks and coatings can be used for the passivation of surfaces, such as metal (e.g. steel, aluminum, etc.) surfaces, including exterior structures such as bridges and buildings. Examples of other uses of the inks and coatings include: UV radiation resistant coatings, abrasion resistant coatings, coatings having permeation resistance to liquids (such as hydrocarbon, alcohols, water, etc.) and/or gases, electrically conductive coatings, static dissipative coatings, and blast and impact resistant coatings. They can be used to make fabrics having electrical conductivity. The inks and coatings can be used in solar cell applications; solar energy capture applications; signage, flat panel displays; flexible displays, including light-emitting diode, organic light-emitting diode, and polymer light-emitting diode displays; backplanes and frontplanes for displays; and lighting, including electroluminescent and OLED lighting. The displays may be used as components of portable electronic devices, such as computers, cellular telephones, games, GPS receivers, personal digital assistants, music players, games, calculators, artificial “paper” and reading devices, etc.

They may be used in packaging and/or to make labels. They may be used in inventory control and anti-counterfeiting applications (such as for pharmaceuticals), including package labels. They may be used to make smart packaging and labels (such as for marketing and advertisement, information gathering, inventory control, information display, etc.). They may be used to form a Faraday cage in packaging, such as for electronic components.

The inks and coatings can be used on electrical and electronic devices and components, such as housings etc., to provide EMI shielding properties. They made be used in microdevices (such as microelectromechanical systems (MEMS) devices) including to provide antistatic coatings.

They may be used in the manufacture of housings, antennas, and other components of portable electronic devices, such as computers, cellular telephones, games, navigation systems, personal digital assistants, music players, games, calculators, radios, artificial “paper” and reading devices, etc.

The inks and coatings can be used to form thermally conductive channels on substrates or to form membranes having desired flow properties and porosities. Such materials could have highly variable and tunable porosities and porosity gradients can be formed. The inks and coatings can be used to form articles having anisotropic thermal and/or electrical conductivities. The coatings can be used to form three-dimensional printed prototypes.

The inks and coatings can be used to make printed electronic devices (also referred to as “printed electronics) that may be in the form of complete devices, parts or sub elements of devices, electronic components, etc.

Printed electronics may be prepared by applying the inks and coatings to the substrate in a pattern comprising an electrically conductive pathway designed to achieve the desired electronic device. The pathway may be solid, mostly solid, in a liquid or gel form, etc.

The printed electronic devices may take on a wide variety of forms and be used in a large array of applications. They may contain multiple layers of electronic components (e.g. circuits) and/or substrates. All or part of the printed layer(s) may be covered or coated with another material such as a cover coat, varnish, cover layer, cover films, dielectric coatings, electrolytes and other electrically conductive materials, etc. There may also be one or more materials between the substrate and printed circuits. Layers may include semiconductors, metal foils, dielectric materials, etc.

The printed electronics may further comprise additional components, such as processors, memory chips, other microchips, batteries, resistors, diodes, capacitors, transistors, etc.

Other applications include, but are not limited to: passive and active devices and components; electrical and electronic circuitry, integrated circuits; flexible printed circuit boards; transistors; field-effect transistors; microelectromechanical systems (MEMS) devices; microwave circuits; antennas; diffraction gratings; indicators; chipless tags (e.g. for theft deterrence from stores, libraries, etc.); security and theft deterrence devices for retail, library, and other settings; key pads; smart cards; sensors; liquid crystalline displays (LCDs); signage; lighting; flat panel displays; flexible displays, including light-emitting diode, organic light-emitting diode, and polymer light-emitting diode displays; backplanes and frontplanes for displays; electroluminescent and OLED lighting; photovoltaic devices, including backplanes; product identifying chips and devices; membrane switches, batteries, including thin film batteries; electrodes; indicators; printed circuits in portable electronic devices (for example, cellular telephones, computers, personal digital assistants, global positioning system devices, music players, games, calculators, etc.); electronic connections made through hinges or other movable/bendable junctions in electronic devices such as cellular telephones, portable computers, folding keyboards, etc.); wearable electronics; and circuits in vehicles, medical devices, diagnostic devices, instruments, etc.

The electronic devices may be radiofrequency identification (RFID) devices and/or components thereof and/or radiofrequency communication device. Examples include, but are not limited to, RFID tags, chips, and antennas. The RFID devices may be ultrahigh frequency RFID devices, which typically operate at frequencies in the range of about 868 to about 928 MHz. Examples of uses for RFIDs are for tracking shipping containers, products in stores, products in transit, and parts used in manufacturing processes; passports; barcode replacement applications; inventory control applications; pet identification; livestock control; contactless smart cards; automobile key fobs; etc.

The electronic devices may also be elastomeric (such as silicone) contact pads and keyboards. Such devices can be used in portable electronic devices, such as calculators, cellular telephones, GPS devices, keyboards, music players, games, etc. They may also be used in myriad other electronic applications, such as remote controls, touch screens, automotive buttons and switches, etc.

Compositions containing nano-graphite oxide sheets and/or nano-graphene sheets, including polymer composites, dispersions, inks and coatings, etc. can be electrically and/or thermally conductive. In some embodiments, the composition can have a conductivity of at least about 10⁻⁶ S/m. It can have a conductivity of about 10⁻⁶ S/m to about 10⁵ S/m, or of about 10⁻⁵ S/m to about 10⁵ S/m. In other embodiments of the invention, the coating has conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m.

In some embodiments, the surface resistivity of the composite (including polymer composites, cured inks and coatings, etc.) may be no greater than about 10000 Ω/square/mil, or no greater than about 5000 Ω/square/mil, or no greater than about 1000 Ω/square/mil or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil.

### EXAMPLES

### Oxidation

The carbon black (0.5 g) (Example 1 used Ketjenblack® EC-600, supplied by AkzoNobel and Example 2 used Vulcan® XC-72R, supplied by Cabot) was added to 23 ml of H₂SO₄ cooled using an ice bath. Then 0.5 g of NaNO₃ catalyst was stirred in. While stirring, 3 g of KMnO₄ was slowly added to the mixture to maintain the temperature below 10° C. The mixture was removed from the ice bath and heated to 35° C. for 30 min. 40 ml of water was then slowly added and the temperature increased to approximately 90° C. and was held at this temperature for 15 min while stirring. Another 140 ml of water was then added followed by the addition of 6 ml of 30% H₂O₂ to dissolve any manganese oxide species. In the case of Example 2, the carbon black was refluxed in 50% nitric acid for 12 h prior to oxidation.

In order to separate the acids and salts from the oxidized material, centrifugation and dialysis were performed. First, the reaction mixture was centrifuged at 3500 RPM for 15 min and the supernatant was removed. The samples were then resuspended in deionized water and placed in 100 Da MWCO dialysis bags and dialyzed until the pH of the surrounding water was neutral. The resulting neutral dialyzed suspension was dried by spray-freeze drying. The suspension was passed through an ultrasonic atomizer to create a fine mist of suspension over liquid nitrogen. The droplets were rapidly frozen and placed in a commercial freeze-dryer until all of the water had sublimed.

The resulting nano-graphite oxide sheets had C/O molar ratios of 2 in the case of Example 1 and 2.2 in the case of Example 2.

### Exfoliation/Reduction

The nano-graphite oxide sheets of Examples 1 and 2 were either formed into a dense film by drop-casting, or the spray freeze-dried sheetswere placed into a tube furnace at about 1100° C. for about 60 seconds to reduce them into nano-graphene sheets. The nano-graphene sheets had C/O molar ratios of about 10 to 20.

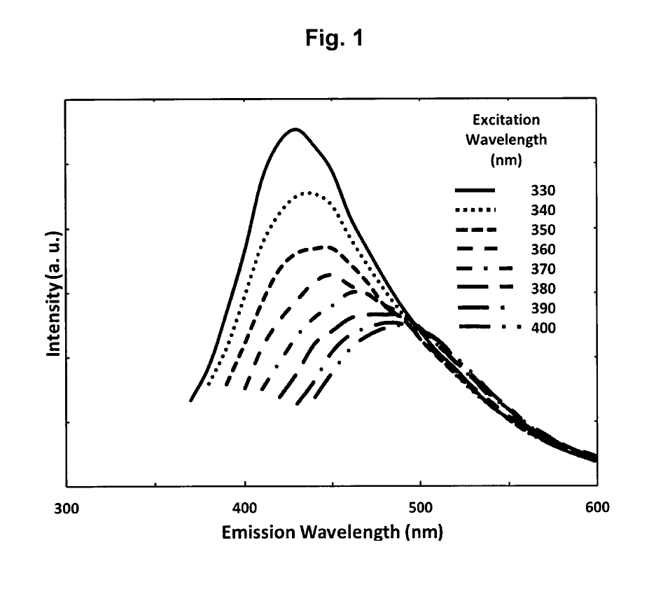

Nano-graphite oxide sheets of Example 1 were redispersed in ammoniated water, pH 11, and solvothermally reduced by heating at 200° C. for 2 h. The resulting suspension showed strong photoluminescence as shown in FIG. 1.

1. Nano-graphene oxide sheets or nano-graphene sheets having a maximum average lateral dimension of about 100 nm.

2. The nano-graphene oxide sheets or nano-graphene sheets of claim 1, having an average maximum lateral dimension of about 50 nm.

3. The nano-graphene oxide sheets or nano-graphene sheets of claim 1, having an average maximum lateral dimension of about 15 nm.

4. The nano-graphene oxide sheets or nano-graphene sheets of claim 1, having an average maximum lateral dimension of about 5 nm.

5. The nano-graphene oxide sheets or nano-graphene sheets of claim 1, having an average thickness of less than about 50 nm.

6. The nano-graphene oxide sheets or nano-graphene sheets of claim 1, having an average thickness of less than about 10 nm.

7. The nano-graphene oxide sheets or nano-graphene sheets of claim 1, having an average thickness of less than about 3 nm.

8. The nano-graphene oxide sheets or nano-graphene sheets of claim 1, having a surface area of at least about 100 m²/g.

9. The nano-graphene oxide sheets or nano-graphene sheets of claim 1, having a surface area of at least about 300 m²/g

10. A method of making nano-graphene oxide sheets, comprising oxidizing at least one carbonaceous material having graphitic domains.

11. The method of claim 10, wherein the carbonaceous material is one or more selected from the group consisting of mesoporous carbons, graphitized mesoporous carbons, carbon black, activated carbon, lampblack, and black carbon (soot).

12. The method of claim 10, wherein the oxidation is done using one or more oxidizing agents selected from the group consisting of nitric acid, sodium nitrate,potassium nitrate, sodium perchlorate, potassium perchlorate, lithium perchlorate, ammonium perchlorate,potassium chlorate, sodium chlorate, chromic acid, potassium chromate, sodium chromate, potassium dichromate, sodium dichromate, hydrogen peroxide, sodium permanganate, potassium permanganate,phosphoric acid (H₃PO₄), phosphorus pentoxide, sodium bisulfate, potassium bisulfate, sodium persulfate, and potassium persulfate.

13. The method of claim 10, wherein the nano-graphene oxide sheets have a maximum average lateral dimension of about 30 nm.

14. The method of claim 10, wherein the nano-graphene oxide sheets have a maximum average lateral dimension of about 10 nm.

15. The method of claim 10, wherein the nano-graphene oxide sheets have an average thickness of less than about 50 nm.

16. The method of claim 10, wherein the nano-graphene oxide sheets have a surface area of at least about 100 m²/g

17. A method of making nano-graphene sheets, comprising reducing nano-graphene oxide sheets having a maximum average lateral dimension of about 50 nm.

18. The method of claim 17, wherein the nano-graphene oxide sheets are themally reduced.

19. The method of claim 17, wherein the nano-graphene oxide sheets are chemically reduced.

20. The method of claim 17, wherein the nano-graphene sheets have a surface area of at least about 100 m²/g.
